(19) United States
(12) Patent Application Publication
(10) Pub. No.: US 2006/0081197 A1
(43) Pub. Date: Apr. 20, 2006

(54) Integrated shock absorbing, non-tangling animal collar and lead

(76) Inventor: Judy Kuykendall, Gladewater, TX (US)

Correspondence Address: Ronald B. Sefrna;Sefrna Associates, P.O. Box 567, Tyler, TX, 75710, US

(21) Appl. No.: 11/080,208

(22) Filed: Mar. 15, 2005

Related U.S. Application Data
(60) Provisional application No. 60/554,078, filed on Mar. 17, 2004.

(51) Int. Cl. A01K 27/00

(52) U.S. Cl. 119/792

(57) ABSTRACT

An integrated resilient, non-tangling collar and lead for dogs and other small animals includes a collar having a throat band with a ring connected at each end of the throat band, and an adjustment loop extending through the rings of the throat band, with an adjustment slider over the adjustment loop to adjust the size of the portion of the loop between the slider and the throat band; and an elongate lead with a resilient section formed of two elastic members with a swivel connected between them.

### RELATED APPLICATION DATA

This application claims the benefit of U.S. Provisional Patent Application Ser. No. 60/554,078, filed Mar. 17, 2004, and titled “Shock Absorbing Non-Tangling Animal Lead”.

### FIELD OF THE INVENTION

The present invention generally relates to animal leads, collars, and harnesses, and in its preferred embodiments more specifically relates to a flexible, shock absorbing, non-tangling integrated lead and collar device for dogs and other small animals.

### BACKGROUND OF THE INVENTION

Conventional collars and leads used with dogs and other small animals have certain disadvantages and drawbacks for both animal and handler. It can be difficult to adjust the fit of a collar appropriately, so the collar is tight enough that the animal cannot easily slip out of it, but not so tight as to restrict breathing and movement. Choke chain collars are sometimes used in an effort to overcome this problem, but they have significant drawbacks and many dog owners and handlers refuse to use them. Although choke chain collars are designed to tighten when the animal or handler pulls on the lead, and then loosen when the pressure is released, the collars may not loosen properly and continue to choke the animal. In addition, chain collars can become tangled in and damage the animal's coat, which is particularly disadvantageous for show animals.

A conventional lead provides no resilience for either animal or handler to cushion or absorb shocks and stress when the animal pulls against the lead. A tight, non-resilient lead can cause the animal to choke or strangle, and shocks that result when the animal hits the end of the lead can be uncomfortable, or even damaging, to both animal and handler. In addition, conventional leads are easily twisted and tangled.

There remains a need for a collar that is easily placed around an animal's neck, that is easily adjustable to fit animals of different sizes, that is comfortable for an animal to wear, that remains securely in place to hold an animal regardless of the direction in which the animal is pulling without being excessively tight, and that will not damage the animal's coat.

There further remains a need for an animal lead that is sufficiently resilient to avoid uncomfortable and damaging shocks, without sacrificing control, and that will not become twisted and tangled when the animals turns and spins.

### SUMMARY OF THE INVENTION

The present invention addresses the needs remaining unfulfilled by collar and lead devices known in the prior art, and that overcomes the disadvantages and drawbacks of the prior art. In a preferred embodiment the invention provides an integrated collar and lead device with a collar portion that may be easily placed over the head and around the neck of a dog or other small animal and easily adjusted for a relatively loose and comfortable fit. When the dog or handler pulls against the lead the collar automatically adjusts itself to tighten around the neck of the animal to provide a secure restraint. The collar of the device provides uniform pressure around the animal's neck rather than applying pressure only to the animal's throat, so the animal is less likely to choke and less likely to incur physical damage. The preferred embodiment of the lead portion of the integrated device includes a resilient section adjacent to the collar portion of the device, where the resilience is most effective. The lead is sufficiently resilient to absorbs shock and reduce stress on both handler and animal, without being so elastic as to result in a loss of control over the animal. A swivel means is provided within the resilient section of the lead so that the lead portion may rotate freely around the swivel independently of the collar portion, and vice versa, to prevent twisting and tangling of the lead.

The structure and features of the invention will be described in more detail with reference to the accompanying drawing figures.

### BRIEF DESCRIPTION OF THE DRAWINGS

FIG. 1 is an upper perspective view of the preferred embodiment of the integrated collar and lead device of the invention.

FIG. 2 is a top view of the collar portion of the preferred embodiment of the device of the invention, with a portion of the shock absorbing section of the lead.

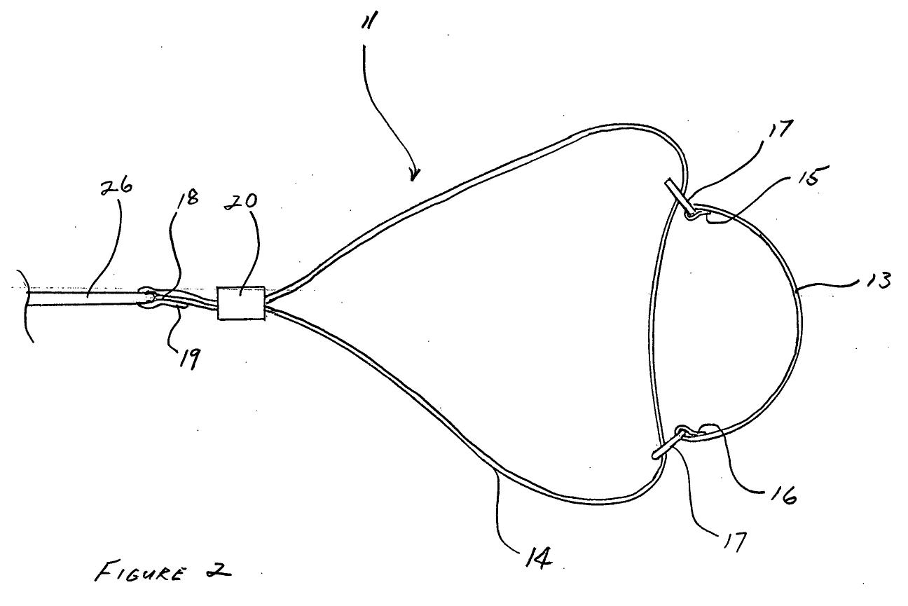

FIG. 3 is a flattened view of the throat band component of the preferred embodiment of the device of the invention.

FIG. 4 is a top view of the shock absorbing section of the preferred embodiment of the lead of the device of the invention

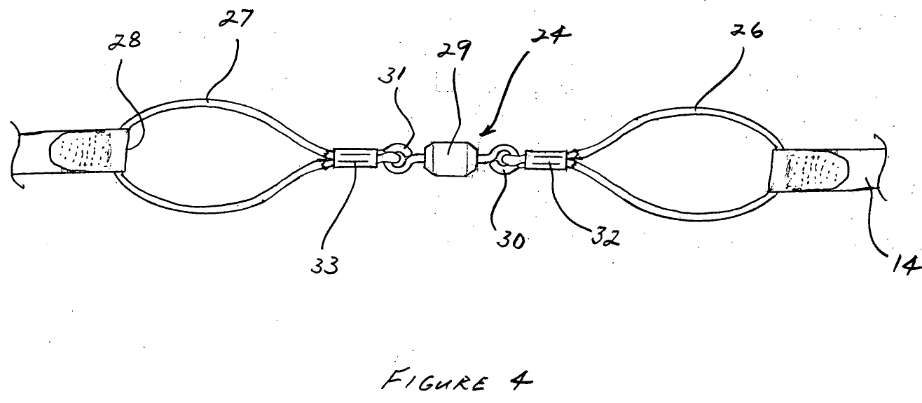

FIG. 5 is a side view of an alternative embodiment of the lead of the device of the invention.

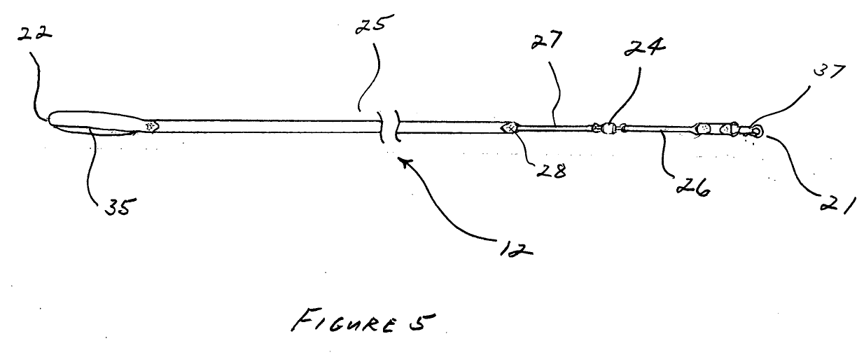

FIG. 6 is a top view of an alternative embodiment of the collar of the device of the invention.

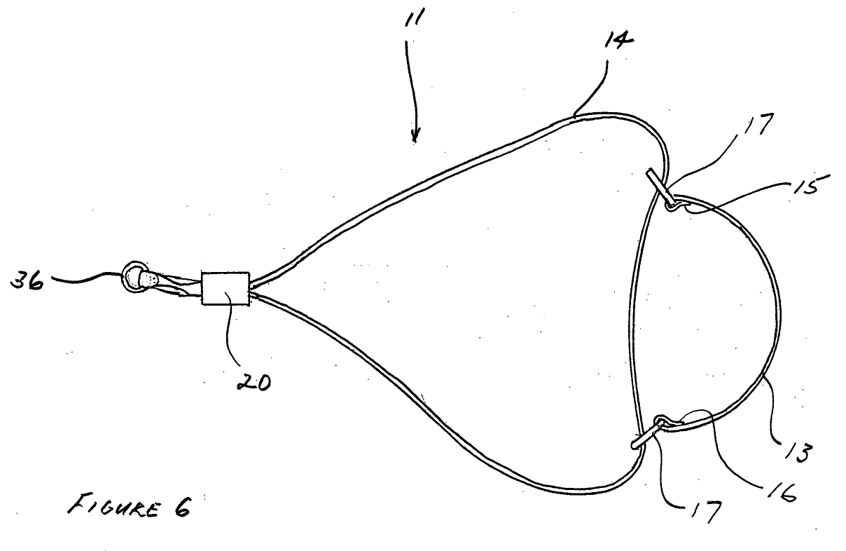

### DETAILED DESCRIPTION OF THE INVENTION

Referring to the drawing figures, the preferred embodiment of the integrated animal lead device of the invention, generally designated by reference number 10, includes a collar portion 11 and a lead portion 12, connected to and extending outwardly from the collar. The preferred length of the integrated device of the invention is between four feet and six feet, but it is to be understood that the overall length is not at all critical to the invention, and both shorter and longer lengths may be used depending on the circumstances of use and the preferences of the user.

The collar 11 of the device of the invention includes a throat band 13 and an adjustment loop 14. The throat band comprises a relatively wide band of flexible material with a first end 15 and a second end 16, to be placed around the throat and extend partially around the neck of the animal with which the lead is to be used. Throat band 13 may be formed of a single band of material or may be formed of two or more narrower bands stitched together or otherwise connected along their edges. Combining two or more bands allows different colors to be used, for example, but has no effect on the function or the throat band. The throat band is preferably sized so that it does not fully surround the neck of the animal, but extends across the throat area and around to approximately the mid-point of the neck on either side. Some variation in the position of the ends of the throat band is accommodated by the design and function of the collar, but it is contemplated that the lead will be provided in different sizes, with throat bands of different lengths, for use with animals of different sizes.

A ring 17 is connected to each of the first and second ends of the throat band 13. In the preferred embodiment the rings are configured as “D” rings and are attached to the throat band by doubling over the ends of the throat band through the rings and stitching them in place. However, it is to be understood that both the configuration of the rings and the means of attachment to the throat band may be varied within the scope of the invention. As non-limiting examples, other ring configurations such as round, square or rectangular, or triangular may be used if desired, so long as free movement of adjustment loop 14 relative to the throat band is allowed. Similarly, other means of attaching the rings to the throat band may be used, such as rivets or clamps, so long as a secure attachment is achieved.

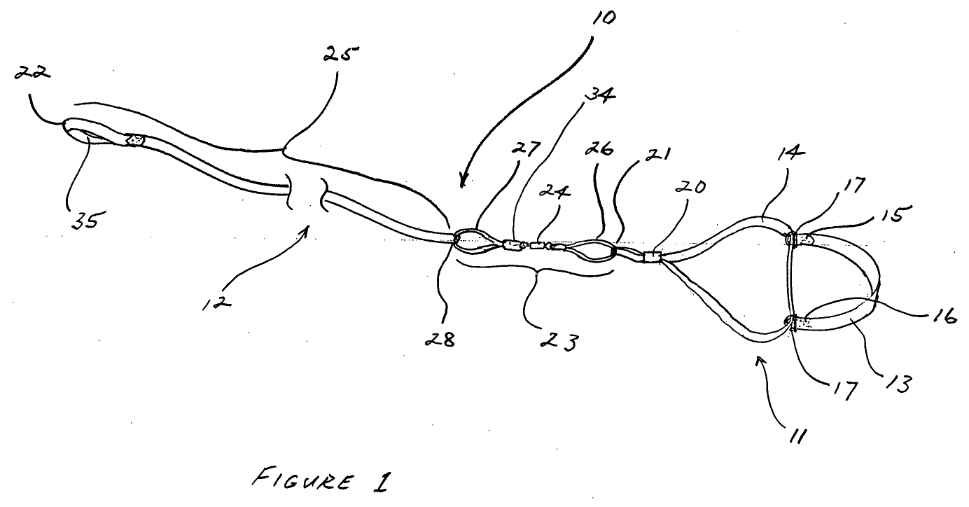

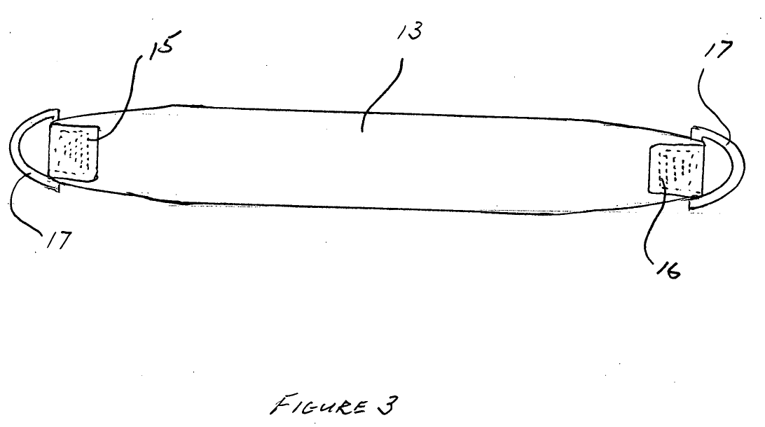

Adjustment loop 14 is an elongate strip of flexible material with a first end 18 and a second end 19, that is passed through both rings 17 and interconnected at its first and second ends to form a closed loop. In the preferred embodiment the adjustment loop is formed as a flat band of a high strength fabric with a relatively hard surface finish that will readily slide through rings 17 without significant resistance. However, it will be understood that other configurations or materials may be used, such as, for example, an oval or round configuration. An adjustment slide 20, preferably formed as a short annular body or hollow tube with open ends and a hollow interior, is placed over the connected ends of the adjustment loop and is slideably disposed between the connected ends and the throat band so that the degree of opening of the adjustment loop adjacent to the throat band can be controlled by moving the adjustment slide closer to or farther away from the throat band. The relationship between the throat band and the adjustment loop is shown in FIGS. 1 and 3. It is preferred that the adjustment slide be relatively tightly fitted to the adjustment loop, so that it can be slid along the adjustment loop without excessive resistance, but will remain in place without slipping during use.

To position the collar section of the lead on an animal, slide 20 is moved away from the throat band to open the adjustment loop and allow the collar section to be easily placed over the head and around the neck of the animal. The throat band is positioned across the throat of the animal, and the portion of the adjustment loop between rings 17 is positioned across the back of the animal's neck. Slide 20 is then moved toward the animal's neck, closing the adjustment loop, until the desired fit is achieved. The collar section should not be tight on the animal's neck, but should be comfortably loose without force being applied to tighten the collar. When force is applied by either or both the animal or the handler, so as to pull on the connected ends of the adjustment loop, the portion of the adjustment loop between rings 17 is shortened, tightening the throat band and the portion of the adjusting band between rings 17 around the animal's neck. Regardless of the direction in which the animal is facing, the application of a pulling force will tighten the collar around the animal's neck, and the collar cannot slip over the animal's head. As soon as the pulling force is released, the adjustment band is free to slide back through rings 17 to loosen the collar around the animal's neck to resume a comfortable fit.

Lead 12 of the preferred embodiment of the invention is an elongate flexible structure with a first end 21 and a second end 22, connected at its first end to collar 11. Lead 12 preferably includes a shock absorbing section 23, a swivel 24 and an elongate handle section 25. In the preferred embodiment of the lead, the shock absorbing section 23 is disposed at or adjacent to the first end of lead 12. In an integrated collar and lead device it is undesirable for either the throat band or the adjustment loop of the collar portion of the device to be formed of a resilient or elastic material. If the adjustment loop is formed of a resilient material it is much more likely to bind in rings 17, and repeated stretching and relaxing of the adjustment loop is likely to move adjustment slide 18 out of position, resulting in the collar portion becoming either too tight or too loose.

Shock absorbing section 23 is preferably formed of two elastic members 26 and 27 formed of a flexible, resilient material that will repeatedly stretch in length when force is applied to its two ends, and return to its original length when the force is released. Swivel 24 is preferably connected between the two elastic members, so that the swivel structure is cushioned between them against shocks and stresses imposed on the lead. It is also preferred that the two elastic members be of approximately equal length and elasticity, although members of unequal length and/or elasticity may be used if desired within the scope of the invention. In the preferred structure, the elastic, shock absorbing members 26 and 27 comprise a first loop and a second loop, respectively. First loop 26 is connected to adjustment loop 14, and second loop 27 is connected to the inner end 28 of the handle section 25 of the lead, with swivel 24 connected between the two loops 26 and 27.

Swivel 24 preferably includes a hollow body 29 with opposed eyes 30 and 31 disposed with one end of each eye retained in body 29 such that eyes 30 and 31 may freely and independently rotate relative to body 29 while remaining securely retained by the body. Swivel 24 should be structured to withstand significant force acting to separate the eyes from the swivel body.

In the preferred structure the first end 18 of the adjustment loop is wrapped over the elastic material of first loop 26 and back over the second end 19 of the adjustment loop and secured thereto by stitching or equivalent means. The distal portion of first loop 26 is doubled, extended through eye 30 of the swivel 24, and back over the adjacent part of the loop material. The first loop is secured in eye 30 by first compression sleeve 32. In similar manner, inner end 28 of handle section 25 is wrapped over the elastic material of second loop 27 and back over itself, and secured. The distal portion of second loop 27 is passed through eye 31 and secured with second compression sleeve 33. The compression are tightly crimped to securely retain the overlapping portions of loops 26 and 27, and the compression sleeves and overlapped ends of the loops are preferably covered by tubing 34. In this preferred configuration swivel 24 is disposed in the resilient section of lead 12, with a length of elastic material on either side of the swivel. This placement not only facilitates construction of the lead, but the presence of resilient material on either side of the swivel connection reduces the stress imposed on the swivel structure and reduces the possibility of failure, and separation, of that component of the lead. The specific construction of swivel 24 is not critical to the invention, and various swivel designs could be used within the scope of the invention, so long as the described function and required strength are achieved. It is contemplated that lighter swivels be used in leads for smaller animals, whereas heavier and stronger swivels be used for larger animals.

Although the described configuration and placement is preferred, it is to be understood that other forms for the shock absorbing section and other placements of the swivel assembly may be used. The preferred loop configuration for the shock absorbing section facilitates the formation of a strong and secure connection between the sections of the lead, and also facilitates the connection of the swivel assembly. However, a single length or strand of resilient material could be used, or multiple strands could be used, if desired. The invention further encompasses the use of alternative structures for the shock absorbing section, such as a coil spring, although such alternatives are considered to be unnecessarily cumbersome, heavy, and less secure, and thus undesirable. Although it is preferred that the compression sleeves and end portions of the elastic material forming the shock absorbing section be covered with tubing 34, the covering may be omitted, or the elastic material may be fully covered, if desired, as a matter of design choice.

The degree of resilience or elasticity of the shock absorbing section can be selected to accommodate the size and weight of the animal with which the lead is to be used. For larger, heavier animals a relatively stiff material would be preferred, and for smaller, lighter animals a lighter material would be used. Loops 26 and 27 may also be formed of materials of different elasticity, so that the lighter loop will absorb initial or smaller forces, and the second loop will come into play as stronger forces are imposed. For heavier animals stiff, solid rubber materials may be required. For smaller animals a tubular material, such as latex surgical tubing, is suitable. In general, it is preferred that the degree of resilience be selected such that the pulling force expected to be exerted by the animal under normal circumstances would not exceed the limits of elasticity of the material, and the shock absorbing section would not be fully extended during such normal use.

The handle section 25 of the lead comprises a length of appropriate lead material, interconnected at one end to the shock absorbing section, and with a loop handle 35 formed at the second end of the lead by overlapping a portion of the lead adjacent to second end 22 and securing the second end 22 to the lead by stitching or other suitable equivalent means. A loop handle is preferred as convenient and secure, but it will be understood that any other type of handle design could be used, or the outer end of the handle section could be left plain, without a handle, if desired.

Although in the principal, preferred embodiment of the invention the collar and lead are formed as an integral unit, the invention is subject to alternative embodiments in which the collar and lead are separately formed, so that the collar section may be used with any type of lead or leash in addition to the shock absorbing lead of the invention, or the shock absorbing lead may be used with any type of collar. In this alternative embodiment, the first and second ends 18 and 19 of the adjustment loop 14 of collar 11 are connected to a ring 36 instead of being directly connected to the first end of lead 12. A snap 37 or other suitable fastening device is connected to the first end 21 of lead 12, for attachment of the lead to a collar.

A particularly preferred material for the construction of the throat band and adjustment loop of the collar and of the non-shock absorbing portion of the lead is a webbing material of nylon or similar textile material. However, the scope of the invention is not limited to any particular materials, or to any particular means of connecting components of the lead, so long as the strength and durability of the selected materials and connections is sufficiently high to maintain the integrity of the lead and assure the comfort and safety of both animals and handlers.

The foregoing description of preferred and certain alternative embodiments of the invention is intended to be illustrative and not limiting. The invention is susceptible to alternative embodiments and variations in structure and materials, all within the scope of the invention.

1. A resilient, non-tangling, integrated animal collar and lead device comprising
a collar to be removably placed around the neck of an animal, the collar having a throat band with a first end and a second end, a first ring connected to said first end of said throat band, and a second ring connected to said second end of said throat band, and having an adjustment loop formed of an elongate strip of flexible material with a first end and a second end, said adjustment loop strip extending through said first and second rings of said throat band, with said strip connected to itself to form a loop, said throat band to be received against the throat of the animal's neck and the portion of the adjustment loop between said rings to be received against the back of the animal's neck opposite said throat band; and
an elongate lead with a first end and a second end, permanently connected at said first end to said adjustment loop of said collar with said lead extending outwardly from said collar, said lead having an elastic section intermediate said first and second ends of said lead, and a non-elastic section, said elastic section having a first elastic member with a first end and a second end, a second elastic member with a first end and a second end, and a swivel means with a first end and a second end, said second end of said first elastic member connected to said first end of said swivel means, and said first end of said second elastic member connected to said second end of said swivel means, such that said swivel means is between said first and second elastic members of said elastic section.

2. The integrated animal collar and lead device of claim 1, wherein said collar further includes an adjustment means slideably disposed on said flexible strip of said adjustment loop for adjusting the size of said loop extending through said rings of said throat band.

3. The integrated animal collar and lead device of claim 2, wherein said adjustment means comprises an open ended tubular body with a hollow interior, and wherein said first and second ends of said strip forming said adjustment loop are extended through said hollow interior of said tubular body.

4. The integrated animal collar and lead device of claim 1, wherein said elastic section of said lead is disposed at said first end of said lead and said first end of said first elastic member is connected to said adjustment loop of said collar.

5. The integrated animal collar and lead device of claim 1, wherein said elastic section of said lead is at said first end of said lead, with said first end of said first elastic member connected to said adjustment loop of said collar.

6. The integrated animal collar and lead device of claim 1, wherein said non-elastic section of said lead comprises a first non-elastic section with a first end and a second end, and a second non-elastic section with a first end and a second end, with said first end of said first non-elastic section connected to said adjustment loop of said collar, said second end of said first non-elastic section connected to said first end of said first elastic member, and said first end of said second non-elastic section connected to said second end of said second elastic member.

7. The integrated animal collar and lead device of claim 1, wherein said first end of said swivel means includes an eye and said first elastic member is formed of a first loop of elastic material extending through said eye of said first end of said swivel means, and wherein said second end of said swivel means includes an eye and said second elastic member is formed of a second loop of elastic material extending through said eye of said second end of said swivel means.

8. The integrated animal collar and lead device of claim 7, wherein said first loop is formed of an elongate elastic first cord with a first end and a second end, with said first and second ends of said first loop extended through said eye of said first end of said swivel means and doubled back over and secured to adjacent portions of said first cord so as to retain said first cord through said eye, and wherein said second loop is formed of an elongate elastic second cord with a first end and a second end, with said first and second ends of said second loop extended through said eye of said second end of said swivel means and doubled back over and secured to adjacent portions of said second cord so as to retain said second cord through said eye.

9. The integrated animal collar and lead device of claim 8, wherein said first and second ends of said first cord are secured to adjacent portions of said first cord by a first crimped sleeve extending around said first and second ends and said adjacent portions of said first cord, and wherein said first and second ends of said second cord are secured to adjacent portions of said second cord by a second crimped sleeve extending around said first and second ends and said adjacent portions of said second cord.

10. The integrated collar and lead device of claim 9, wherein said first and second crimped sleeves and portions of said respective first and second cords adjacent thereto are covered.

11. The integrated collar and lead device of claim 1, wherein said first and second rings of said throat band are D rings, and wherein said rings are connected to said respective ends of said throat band by stitching.

12. The integrated animal collar and lead device of claim 1, wherein said lead includes a loop handle formed at said second end of said lead.

13. A resilient, shock absorbing lead device for an animal, to be connected to a restraint worn by the animal, comprising
an elongate flexible non-resilient section having a first end and a second end;
a flexible resilient section having a first elastic member with a first end and a second end, a second elastic member with a first end and a second end, and a swivel means with a first end and a second end, said second end of said first elastic member connected to said first end of said swivel means, said first end of said second elastic member connected to said second end of said swivel means, such that said swivel means is between said first and second elastic members of said resilient section, thereby cushioning said swivel means from shocks and stress imposed upon said lead, and said second end of said second elastic member connected to said first end of said non-resilient section; and
a fastening means interconnected to said first end of said first end of said first elastic member for connecting said lead to the restraint worn by the animal.

14. The lead device of claim 13, further comprising a second non-resilient section interconnecting said fastening means to said first end of said resilient section, said second non-resilient section having a first end connected to said fastening means and a second end connected to said first end of said first elastic member of said resilient section.

15. The lead device of claim 13, wherein said first and second elastic members are of approximately equal length and of approximately equal elasticity.

16. The lead device of claim 13, wherein said first end of said swivel means includes an eye and said first elastic member is formed of a first loop of elastic material extending through said eye of said first end of said swivel means, and wherein said second end of said swivel means includes an eye and said second elastic member is formed of a second loop of elastic material extending through said eye of said second end of said swivel means.

17. A combination animal collar and resilient lead device, comprising
a collar to be removably placed around the neck of an animal, the collar having a throat band with a first end and a second end, a first ring connected to said first end of said throat band, and a second ring connected to said second end of said throat band, having an adjustment loop formed of a flexible material, said adjustment loop strip extending through said first and second rings of said throat band, said throat band to be received against the throat of the animal's neck and the portion of the adjustment loop between said rings to be received against the back of the animal's neck opposite said throat band, and having a hollow open ended tubular adjustment slider moveably disposed on said adjustment loop so as to divide said adjustment loop into an inside portion extending through said rings of said throat band and an outside portion, said slider moveable for adjusting the relative sizes of said inside portion and said outside portion of said adjusting loop; and
a lead connected to said outside portion of said adjusting loop and extending outwardly therefrom, said lead having an elongate flexible non-resilient section with a first end and a second end, and a flexible resilient section having a first elastic member with a first end and a second end, a second elastic member with a first end and a second end, and a swivel means with a first end and a second end, said second end of said first elastic member connected to said first end of said swivel means, said first end of said second elastic member connected to said second end of said swivel means, such that said swivel means is between said first and second elastic members of said resilient section, thereby cushioning said swivel means from shocks and stress imposed upon said lead, and said second end of said second elastic member connected to said first end of said non-resilient section.

18. The combination animal collar and resilient lead device of claim 17, wherein said lead is permanently connected to said outside portion of said adjusting loop of said collar.

19. The combination animal collar and resilient lead device of claim 17, wherein said lead is removably connected to said outside portion of said adjusting loop of said collar.
